(19) United States
(12) Patent Application Publication
(10) Pub. No.: US 2024/0096298 A1
(43) Pub. Date: Mar. 21, 2024

(54) DISPLAY DIAGNOSIS DEVICE, DISPLAY DIAGNOSIS METHOD, AND NON-TRANSITORY COMPUTER READABLE MEDIUM

(71) Applicant: FUJIFILM Business Innovation Corp., Tokyo (JP)

(72) Inventor: Mami YOKOHASHI, Kanagawa (JP)

(73) Assignee: FUJIFILM Business Innovation Corp., Tokyo (JP)

(21) Appl. No.: 18/178,544

(22) Filed: Mar. 6, 2023

(30) Foreign Application Priority Data
Sep. 16, 2022 (JP) 2022-147869

(51) Int. Cl. G09G 5/02

(52) U.S. Cl. CPC G09G 5/026; G09G 2320/0666

(57) ABSTRACT

A display diagnosis device includes a processor configured to: receive a setting value of a white color on a display from a user; based on characteristics data and the setting value of the white color, the characteristics data being a combination of input color data representing a color and a color measurement value obtained by measuring a color displayed based on the input color data on the display, identify a color gamut that is a part of a color space that is able to be displayed on the display; and in a case where a target color is not present within the identified color gamut, notify the user that the target color is not able to be reproduced on the display.

### CROSS-REFERENCE TO RELATED APPLICATIONS

This application is based on and claims priority under 35 USC 119 from Japanese Patent Application No. 2022-147869 filed Sep. 16, 2022.

### BACKGROUND

### (i) Technical Field

The present disclosure relates to a display diagnosis device, a display diagnosis method, and a non-transitory computer readable medium.

### (ii) Related Art

Adjusting the color profile of a display so that the same image data on different displays are displayed in equivalent display colors has been performed.

For example, in Japanese Unexamined Patent Application Publication No. 2018-46398, a reproducibility determination device that determines, based on a color measurement value obtained by measuring a white color displayed on a display, whether or not a color reproduction target that is set based on brightness and color temperature is able to be reproduced on the display, is disclosed.

### SUMMARY

A color gamut, which is a part of a color space that is able to be displayed on a display, may vary according to a setting value of a white color. Thus, even in the case where the color profile of the display is set so that the white color desired by a user is able to be displayed, other target colors other than the desired white color may not be able to be displayed.

In such a case, the user needs to set up the color profile again, and resetting of the color profile requires time and effort.

Aspects of non-limiting embodiments of the present disclosure relate to, prior to setting of a color profile, allowing a user to understand that a target color is not present within a color gamut that varies according to an input setting value of a white color.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a display diagnosis device including a processor configured to: receive a setting value of a white color on a display from a user; based on characteristics data and the setting value of the white color, the characteristics data being a combination of input color data representing a color and a color measurement value obtained by measuring a color displayed based on the input color data on the display, identify a color gamut that is a part of a color space that is able to be displayed on the display; and in a case where a target color is not present within the identified color gamut, notify the user that the target color is not able to be reproduced on the display.

### BRIEF DESCRIPTION OF THE DRAWINGS

Exemplary embodiments of the present disclosure will be described in detail based on the following figures, wherein:

FIG. 1 is a schematic diagram of a configuration of a display diagnosis device according to an exemplary embodiment;

FIG. 2 is a first diagram illustrating an example of a user interface;

FIG. 3 is a conceptual diagram illustrating a change of a setting value of a white color;

FIG. 4 is a diagram illustrating a change of a color gamut according to a setting value of a white color;

FIG. 5 is a second diagram illustrating an example of the user interface;

FIG. 6 is a diagram illustrating target colors and a color gamut;

FIG. 7 is a diagram illustrating a first notification example for the case where a white color set on a display is not able to be reproduced;

FIG. 8 is a diagram illustrating a second notification example for the case where a white color set on the display is not able to be reproduced;

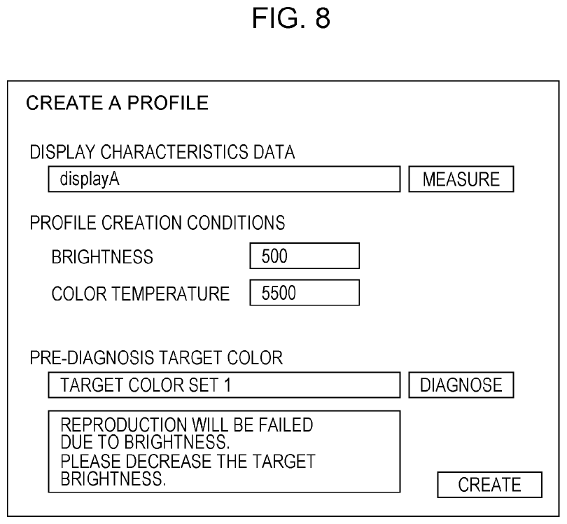

FIG. 9 is a diagram illustrating a first notification example for the case where a target color is not able to be reproduced on the display;

FIG. 10 is a diagram illustrating a second notification example for the case where a target color is not able to be reproduced on the display;

FIG. 11 is a diagram illustrating a notification example for the case where a target color is able to be reproduced on the display;

FIG. 12 is a first flowchart illustrating the flow of a process performed by a display diagnosis device according to an exemplary embodiment; and

FIG. 13 is a second flowchart illustrating the flow of the process performed by the display diagnosis device according to the exemplary embodiment.

### DETAILED DESCRIPTION

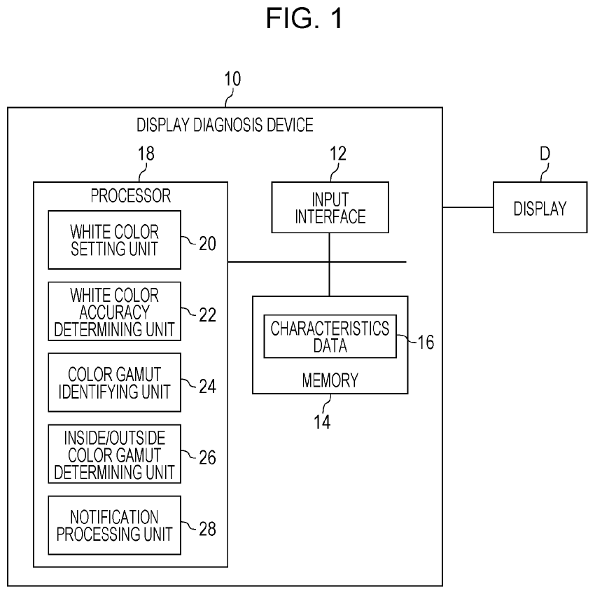

FIG. 1 is a schematic diagram of a configuration of a display diagnosis device 10 according to an exemplary embodiment. The display diagnosis device 10 is a device that performs processing for displaying a screen on a display D, processing for adjusting the color profile of the display D, processing for, prior to adjustment of the color profile, making a diagnosis regarding whether or not a target color, which is a color that a user wants to display on the display D, is able to be displayed, and the like. Typically, the display diagnosis device 10 is a personal computer. However, the display diagnosis device 10 may be any type of device as long as it is capable of performing the processing mentioned above. The display D is, for example, a liquid crystal panel, an organic electroluminescence (EL), or the like.

An input interface 12 includes, for example, a mouse, a keyboard, a touch panel, or the like. The input interface 12 is used by the user to input various instructions to the display diagnosis device 10.

A memory 14 includes, for example, a hard disk drive (HDD), a solid state drive (SSD), a read only memory (ROM), a random access memory (RAM), or the like. The memory 14 may be provided separately from a processor 18, which will be described later, or at least part of the memory 14 may be provided inside the processor 18. A display diagnosis program for operating units of the display diagnosis device 10 is stored in the memory 14. The display diagnosis program may be stored in, for example, a computer-readable non-transitory recording medium such as a universal serial bus (USB) memory or a compact disc-read only memory (CD-ROM). The display diagnosis device 10 is capable of reading the display diagnosis program from the above-mentioned recording medium and executing the display diagnosis program. Furthermore, as illustrated in FIG. 1, characteristics data 16 is stored in the memory 14.

The characteristics data 16 is data composed of input color data indicating a color to be input to the display D and a color measurement value obtained by measuring the color displayed based on the input color data on the display D. Input color data indicating a color represents, for example, values (typically, 0 to 255) of red (R), green (G), and blue (B). In this exemplary embodiment, a color measurement value is represented by a Lab color space and, specifically, expressed by a and b values. A color measurement value is not necessarily expressed by a and b values in the Lab color space and may be expressed by, for example, x and y values in an XYZ color space.

The characteristics data 16 is acquired as described below. An acquirer of the characteristics data 16 causes a plurality of colors represented by a plurality of pieces of input color data to be displayed on the display D and causes a colorimeter to measure colors displayed on the display D. In this exemplary embodiment, a plurality of colors including white are measured by the colorimeter. The acquirer of the characteristics data 16 associates the input color data of the colors with color measurement values and causes a plurality of combinations of input color data and color measurement values to be stored as the characteristics data 16 into the memory 14.

As illustrated in FIG. 1, based on the display diagnosis program stored in the memory 14, the processor 18 implements functions as a white color setting unit 20, a white color accuracy determining unit 22, a color gamut identifying unit 24, an inside/outside color gamut determining unit 26, and a notification processing unit 28. With the functions of the processor 18, prior to creation or (adjustment) of the color profile of the display D, a diagnosis of the display D is made, in particular, when the user sets a setting value of a white color, a diagnosis (in other words, simulation) regarding whether or not a target color desired by the user is present within a color gamut that varies according to the setting value of the white color is made.

The diagnosis is conducted as roughly described below. As described above or as described in detail below, the color gamut of the display D varies according to a setting value of a white color. Thus, first, the processor 18 receives a setting value of the white color from the user, and then identifies the color gamut of the display D based on the setting value of the white color. After that, the processor 18 determines whether or not a target color, which is a color that the user wants to display on the display D, is present within the identified color gamut. In the case where the target color is not present within the color gamut, the processor 18 provides a notification to the user. The details of the functions implemented by the processor 18 will be described below.

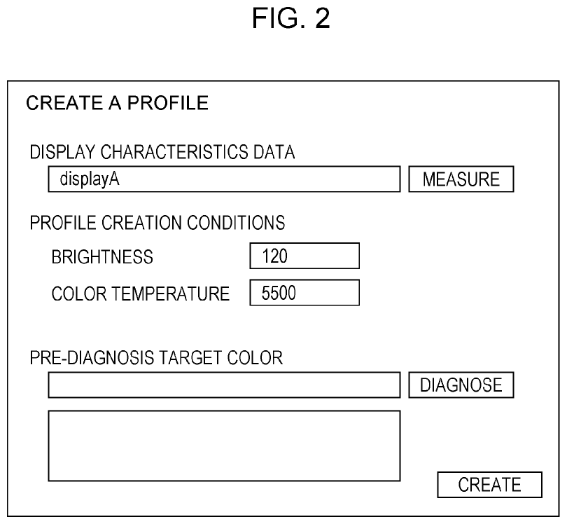

The white color setting unit 20 receives a setting value of the white color on the display D from the user and determines, based on the received setting value, the setting value of the white color to be used for diagnosis. The user inputs, using the input interface 12, the setting value of the white color to the display diagnosis device 10. For example, the processor 18 causes a user interface illustrated in FIG. 2 to be displayed on the display D. The user interface includes a field to which a setting value of the white color is to be input. In the example of FIG. 2, “brightness” and “color temperature” of “profile creation conditions” serve as a setting value of the white color. That is, in this exemplary embodiment, the user inputs the brightness and color temperature of the white color as a setting value of the white color.

The white color accuracy determining unit 22 determines whether or not the white color set by the white color setting unit 20 is able to be reproduced (displayed) on the display D. Specifically, as described below, the white color accuracy determining unit 22 determines, based on the characteristics data 16 and the setting value of the white color set by the white color setting unit 20, whether or not the white color is able to be reproduced on the display D. A plurality of pieces of characteristics data 16 corresponding to a plurality of displays D may be stored in the memory 14. In this case, on the user interface illustrated in FIG. 2, the user may be able to select characteristics data 16 to be used for determining whether or not the white color is able to be reproduced on the display D or for identifying a color gamut described later. In the example of FIG. 2, the user is able to select characteristics data 16 in a field for display characteristics data. A measure button may be provided in the user interface. The user may be able to acquire the characteristics data 16 for the display D by operating the measure button.

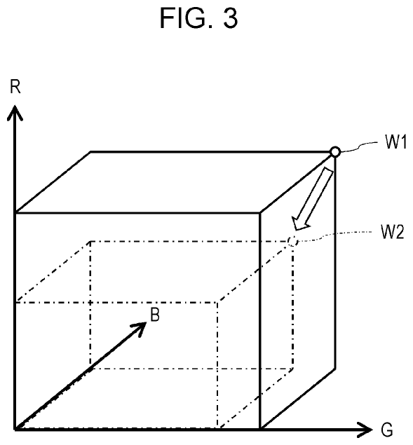

Setting a white color is setting a color where all the R, G, and B values of input color data are 255 (hereinafter, may be represented by (R,G,B)=(255,255,255)). FIG. 3 is a conceptual diagram illustrating a change of a setting value of the white color. In FIG. 3, the R, G, and B values are represented three-dimensionally. For example, in the case where a setting value of the white color is represented by W1, coordinates of W1 are represented by (R,G,B)=(255,255,255), and input color data is represented within a cube indicated by solid lines. For example, the color represented by W1 represents input color data of the white color for the case where the characteristics data 16 is acquired.

When the white color is set by the white color setting unit 20, coordinates of the white color in the RGB coordinate space are changed. In this example, a bluish white color is set as the white color, and coordinates of W2, which has slightly smaller R and G values than those of W1 and the same B value as that of W1, indicate the white color. In this case, the color represented by W2 is merely a white color. Thus, the coordinates of W2 are represented by (R,G,B)=(255,255,255), and input color data is represented within a cube indicated by one-dot chain lines. However, in the case where the setting value of the white color represented by W1 is defined as a reference, the coordinates of W2 are represented by, for example, (R,G,B)=(250, 250, 255) instead of (R,G,B)=(255,255,255).

As described above, when a setting value of a white color is changed, even if input color data (R,G,B) before setting of the white color is changed (here, the case where the white color is represented by W1), that is, input color data (R,G,B) represented by the characteristics data 16, and input color data (R,G,B) of a setting value of a white color set by the white color setting unit 20 (here, the case where the white color is represented by W2, which is different from W1) are the same, these two pieces of input color data (R,G,B) represent different colors. In other words, input color data (R,G,B) representing the same color is different between the case where the white color is represented by W1 and the case where the white color is represented by W2. Depending on the brightness and color temperature set by the white color setting unit 20, at least one value of the input color data (R,G,B) of W2 for the case where the setting value of the white color represented by W1 is defined as a reference may exceed 255.

The white color accuracy determining unit 22 creates, based on the characteristics data 16, a look up table (LUT) that indicates the relationship between input color data (R,G,B) represented by the characteristics data 16 (in this example, the case where the white color is represented by W1) and input color data (R,G,B) represented by the white color set by the white color setting unit 20 (in this example, the case where the white color is represented by W2).

More particularly, the white color accuracy determining unit 22 first refers to the characteristics data 16 and identifies input color data (R,G,B) corresponding to the brightness and color temperature (corresponding to a color measurement value) of the white color set by the white color setting unit 20 where the case of W1 is defined as a reference. For example, input color data (R,G,B)=(250,250,255) is identified. Then, the white color accuracy determining unit 22 associates the input color data (R,G,B)=(255,255,255) for the case where the white color is represented by W2 with the identified input color data (R,G,B) (250, 250, 255) in the LUT. With reference to the LUT, in the example described above, conversion may be performed in such a manner that the R and G values are converted from 255 to 250 (or vice versa) and the B value is maintained at 255. The white color accuracy determining unit 22 identifies the correspondence between a plurality of pieces of input color data so that other colors are also able to be converted at a proportion similar to the white color and creates an LUT based on the identified correspondence. With the use of the LUT created as described above, the input color data (R,G,B) for the case where the white color set by the white color setting unit 20 is defined as a reference may be converted into the input color data (R,G,B) represented by the characteristics data 16. The LUT is not only used to determine whether or not a white color is able to be reproduced but also used to calculate a color gamut as described later.

Next, by applying the created LUT to the input color data representing the white color, that is, the input color data (R,G,B)=(255,255,255), the white color accuracy determining unit 22 converts the input color data (R,G,B)=(255,255,255) representing the white color into input color data (R,G,B) of the white color set by the white color setting unit 20 for the case where the white color represented by the characteristics data 16 (in the example of FIG. 3, the white color represented by W1) is defined as a reference. Then, the white color accuracy determining unit 22 identifies, based on the converted input color data (R,G,B) and the characteristics data 16, the brightness and color temperature of the white color set by the white color setting unit 20. Specifically, if a color measurement value is associated with the converted input color data (R,G,B) in the characteristics data 16, the white color accuracy determining unit 22 is able to identify, based on the color measurement value, the brightness and color temperature of the white color set by the white color setting unit 20. If a color measurement value is not associated with the converted input color data (R,G,B) in the characteristics data 16, the white color accuracy determining unit 22 is able to estimate, based on a color measurement value associated with adjacent input color data (R,G,B), the brightness and color temperature of the white color set by the white color setting unit 20.

After that, the white color accuracy determining unit 22 compares the identified brightness with the brightness set by the white color setting unit 20. Furthermore, the white color accuracy determining unit 22 compares the identified color temperature with the color temperature set by the white color setting unit 20. In the case where, based on the results of the comparison, each of the difference in the brightness and the difference in the color temperature is less than a predetermined threshold, the white color accuracy determining unit 22 determines that the white color set by the white color setting unit 20 is able to be reproduced on the display D. In contrast, in the case where, based on the results of the comparison, at least one of the difference in the brightness and the difference in the color temperature is equal to or more than the predetermined threshold, the white color accuracy determining unit 22 determines that the white color set by the white color setting unit 20 is not able to be reproduced on the display D.

Furthermore, in the case where it is determined that the white color set by the white color setting unit 20 is not able to be reproduced on the display D, the white color accuracy determining unit 22 may identify how much setting value of the white color is required in order that the white color is reproduced on the display D. For example, the maximum brightness and the highest color temperature at which the white color is able to be displayed are obtained. Then, the white color accuracy determining unit 22 calculates the difference between the identified brightness and the maximum brightness or the difference between the identified color temperature and the highest color temperature.

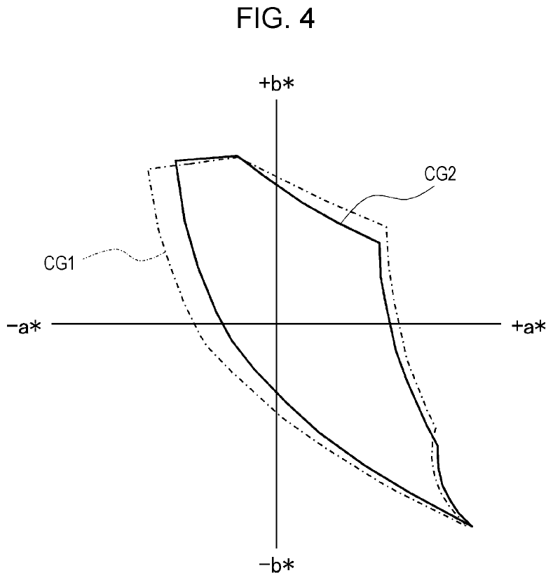

The color gamut identifying unit 24 identifies, based on the characteristics data 16 and the setting value of the white color set by the white color setting unit 20, a color gamut, which is a part of a color space that is able to be displayed on the display D. As described above, the color gamut of the display D varies according to the setting value of a white color. FIG. 4 is a diagram illustrating a change of the color gamut according to the setting value of the white color. For example, in the case where the color gamut for the case where the white color is represented by W1 in FIG. 3 is a range indicated by CG1, the color gamut for the case where the white color is represented by W2 in FIG. 3 is a range indicated by CG2. In this case, even if the white color represented by W2 is able to be reproduced on the display D, a color outside the color gamut CG2 is not able to be reproduced.

First, in order to identify the color gamut, a plurality of pieces of input color data (R,G,B) are prepared. In this exemplary embodiment, the plurality of pieces of input color data (R,G,B) include white (R,G,B)=(255,255,255), red (R,G,B)=(255,0,0), green (R,G,B)=(0,255,0), and blue (R,G,B)=(0,0,255). However, the plurality of pieces of input color data (R,G,B) are not limited to those mentioned above. Red, green, and blue are colors located at end parts of a color gamut in the Lab color space or the XYZ color space.

The color gamut identifying unit 24 applies the LUT created by the white color accuracy determining unit 22 to the prepared plurality of pieces of input color data (R,G,B) for identifying a color gamut. Thus, the plurality of pieces of input color data (R,G,B) including white, red, green, and blue for the case where the white color set by the white color setting unit 20 is represented by (R,G,B)=(255,255,255) are able to be converted into a plurality of pieces of input color data (R,G,B) for the case where the white color represented by the characteristics data 16 is defined as a reference. Then, the color gamut identifying unit 24 identifies, based on the converted plurality of pieces of input color data (R,G,B) of the individual colors and the characteristics data 16, the color gamut of the display D determined based on the setting value of the white color set by the white color setting unit 20. Specifically, the color gamut identifying unit 24 identifies, based on color measurement values associated with the converted input color data (R,G,B) of the individual colors that are identified with reference to the characteristics data 16, the color gamut of the display D.

When the white color accuracy determining unit 22 determines that the white color set by the white color setting unit 20 is able to be reproduced on the display D, the color gamut identifying unit 24 may identify the color gamut of the display D. In other words, when the white color accuracy determining unit 22 determines that the white color set by the white color setting unit 20 is not able to be reproduced on the display D, the color gamut identifying unit 24 does not necessarily identify the color gamut of the display D.

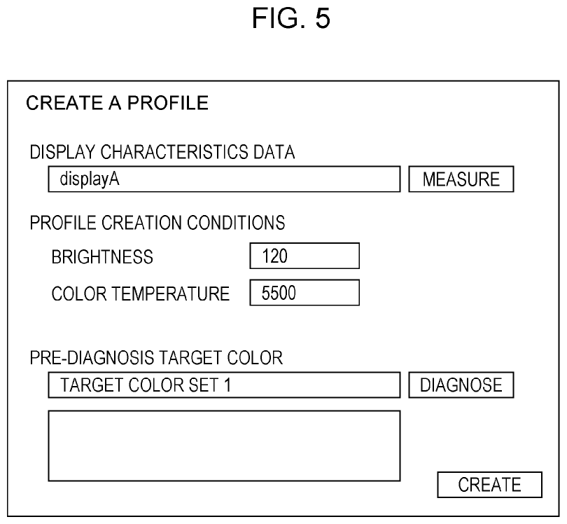

The inside/outside color gamut determining unit 26 determines whether or not a target color, which is a color that the user wants to display on the display D, is present within the color gamut of the display D identified by the color gamut identifying unit 24 (hereinafter, may also be referred to simply as a “color gamut”). The target color may be a predetermined color set (for example, a set of colors located at end parts of the color gamut). However, in this exemplary embodiment, the inside/outside color gamut determining unit 26 determines a target color in accordance with an instruction from the user. For example, as illustrated in FIG. 5, the processor 18 causes a user interface including a field in which a target color is to be set (in the example of FIG. 5, a field “pre-diagnosis target color” to be displayed on the display D. When the user inputs a target color into the field, the inside/outside color gamut determining unit 26 receives the target color from the user.

Preferably, one or a plurality of pieces of target color set data each representing a plurality of target colors are prepared in advance, and the inside/outside color gamut determining unit 26 determines, based on target color set data selected by the user, a target color. Specifically, in the field “pre-diagnosis target color” illustrated in FIG. 5, the user may be able to select a desired piece of target color set data from the plurality of pieces of target color set data prepared in advance.

In this exemplary embodiment, the user interface illustrated in FIG. 5 includes a diagnose button. When the user designates a target color and then operates the diagnose button, the inside/outside color gamut determining unit 26 determines whether or not the target color is present within the color gamut. In the case where there are a plurality of target colors, only when all the plurality of target colors are present within the color gamut, the inside/outside color gamut determining unit 26 determines that the target color is present within the color gamut. In contrast, in the case where at least one of the plurality of target colors is not present within the color gamut, the inside/outside color gamut determining unit 26 determines that the target color is not present within the color gamut.

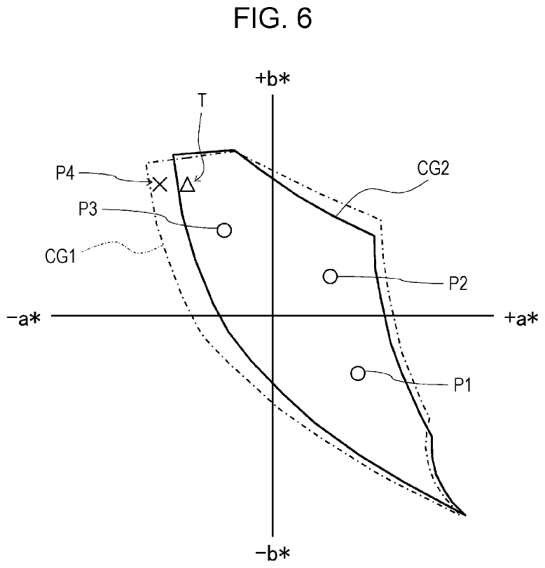

As illustrated in FIG. 6, it is assumed that the color gamut identified by the color gamut identifying unit 24 is the range indicated by CG2 and there are four target colors P1 to P4. In this case, the target colors P1 to P3 are present within the color gamut CG2, whereas the target color P4 is not present within the color gamut CG2. Thus, in this case, the inside/outside color gamut determining unit 26 determines that the target color is not present within the color gamut.

As described above, in the case where at least part of target colors is not present within the color gamut, when the color profile represented by the white color set by the white color setting unit 20 is applied to the display D, if image data including a target color that is not present within the color gamut is displayed on the display D, part of the colors of the image data is not reproduced correctly (as indicated by input color data). In the example of FIG. 6, the target color P4 is converted into a color T, which is close to the target color P4 and is present within the color gamut CG2, and the color T, into which the target color P4 has been converted, is reproduced on the display D. In the case where a target color is not present within the color gamut, the inside/outside color gamut determining unit 26 may calculate in advance the color difference between the target color (in the example of FIG. 6, the target color P4) and the color that is close to the target color and is present within the color gamut (in the example of FIG. 6, the color T). Various existing methods are available as a method for converting the target color P4 into the color T and a method for calculating the color difference. Thus, detailed description of those methods will be omitted.

The notification processing unit 28 performs processing for notifying the user of a determination result of the white color accuracy determining unit 22. Specifically, when the white color accuracy determining unit 22 determines that the white color set by the white color setting unit 20 is not able to be reproduced on the display D, the notification processing unit 28 notifies the user that the white color is not able to be reproduced on the display D.

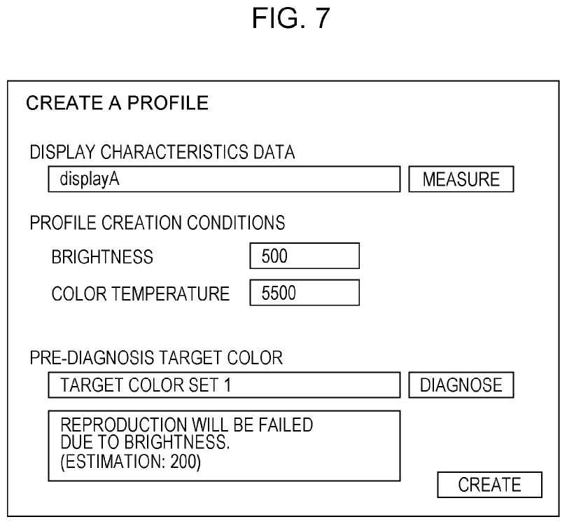

Furthermore, in the case where the white color set by the white color setting unit 20 is not able to be reproduced on the display D and a setting value of the white color includes a plurality of items as in this exemplary embodiment (in this exemplary embodiment, brightness and color temperature), the notification processing unit 28 may notify the user that the white color is not able to be reproduced on the display D due to which item of the plurality of items. For example, as illustrated in FIG. 7, the notification processing unit 28 causes a message such as “Reproduction will be failed due to brightness.” to be displayed on the user interface. Obviously, if color temperature is the reason for not being able to reproduce the white color, the notification processing unit 28 causes a message such as “Reproduction will be failed due to color temperature.” to be displayed on the user interface.

Furthermore, the notification processing unit 28 may notify the user of how much setting value of the white color set by the white color setting unit 20 is required in order that the white color is able to be reproduced on the display D, identification of how much setting value of the white color is required in order that the white color is able to be reproduced on the display D being performed by the white color accuracy determining unit 22. For example, as illustrated in FIG. 7, the notification processing unit 28 may cause a message such as “Reproduction will be failed due to brightness. (estimation: 200)” to be displayed on the user interface. This message indicates that the white color is able to be reproduced on the display D when the brightness is 200. Furthermore, in the case where the reason for not being able to reproduce the white color is color temperature, the notification processing unit 28 may cause a message such as “Reproduction will be failed due to color temperature. (estimation: 6000)” to be displayed on the user interface.

Furthermore, in the case where the white color set by the white color setting unit 20 is not able to be reproduced on the display D, the notification processing unit 28 may notify the user of a resolution method for reproducing the white color on the display D. For example, in the case where the brightness set by the white color setting unit 20 is higher than the maximum brightness identified by the white color accuracy determining unit 22, the notification processing unit 28 causes a message such as “Please decrease the target brightness.” to be displayed on the user interface. Furthermore, in the case where the color temperature set by the white color setting unit 20 is higher than the highest color temperature identified by the white color accuracy determining unit 22, the notification processing unit 28 causes a message such as “Please decrease the target color temperature.” to be displayed on the user interface.

In contrast, when the white color accuracy determining unit 22 determines that the white color set by the white color setting unit 20 is able to be reproduced on the display D, the notification processing unit 28 notifies the user that the white color is able to be reproduced on the display D.

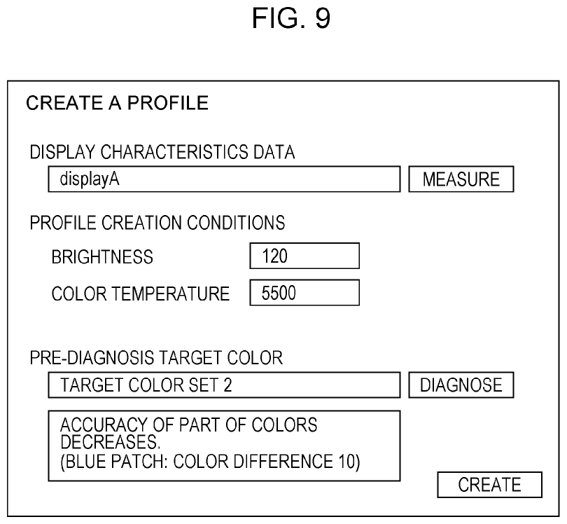

Furthermore, the notification processing unit 28 performs processing for notifying the user of a determination result of the inside/outside color gamut determining unit 26. Specifically, when the inside/outside color gamut determining unit 26 determines that a target color is not present within the color gamut, the notification processing unit 28 notifies the user that the target color is not able to be reproduced on the display D. For example, as illustrated in FIG. 9, the notification processing unit 28 causes a message such as “Accuracy of part of colors decreases.” to be displayed on the user interface.

When the inside/outside color gamut determining unit 26 determines that a target color including a plurality of target colors is not present within the color gamut, the notification processing unit 28 may notify the user of a target color that is not present within the color gamut among the plurality of target colors. For example, as illustrated in FIG. 9, the notification processing unit 28 causes a message such as “(Blue patch)” to be displayed on the user interface.

Furthermore, in the case where the inside/outside color gamut determining unit 26 determines that a target color is not present within the color gamut, the notification processing unit 28 may notify the user of the color difference between the target color that is not present within the color gamut and the color gamut. For example, as illustrated in FIG. 9, the notification processing unit 28 causes a message such as “(Blue patch: color difference 10)” to be displayed on the user interface. The color difference is calculated by the inside/outside color gamut determining unit 26, as described above.

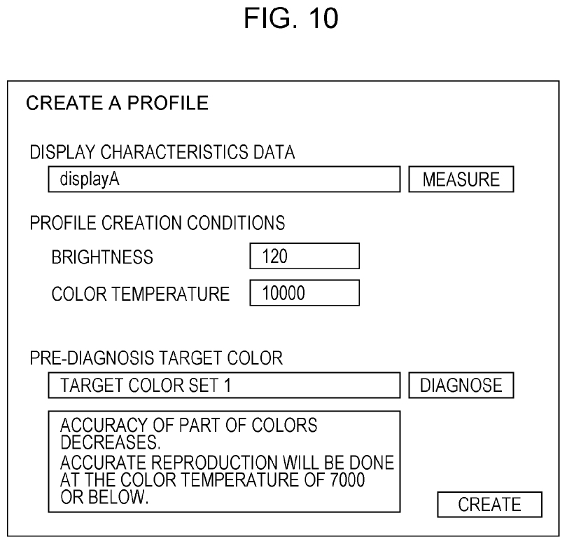

Furthermore, in the case where the inside/outside color gamut determining unit 26 determines that a target color is not present within the color gamut, the notification processing unit 28 may identify a setting value of the white color that allows the target color to be included within the color gamut and notify the user of the identified setting value. For example, as illustrated in FIG. 10, the notification processing unit 28 causes a message such as “Accurate reproduction will be done at the color temperature of 7000 or below.” to be displayed on the user interface.

The setting value of the white color that allows the target color that is not present within the color gamut to be included within the color gamut is able to be identified by, for example, processing described below. First, while the white color setting unit 20 is changing the setting value of the white color little by little, the color gamut identifying unit 24 identifies a color gamut corresponding to the changed setting value of the white color. Then, the inside/outside color gamut determining unit 26 determines whether or not the target color is present within the identified color gamut. By repeatedly performing the above-mentioned processing, the setting value of the white color at the time when the inside/outside color gamut determining unit 26 determines that the target color is present within the identified color gamut is able to be identified as the setting value of the white color that allows the target color that is not present within the color gamut to be included within the color gamut.

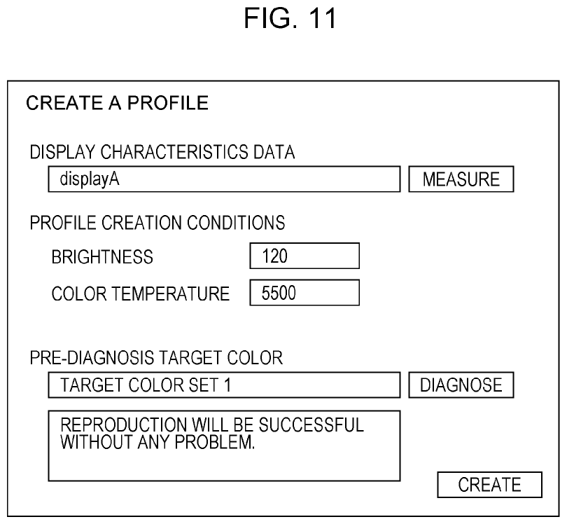

In contrast, when the inside/outside color gamut determining unit 26 determines that the target color is present within the color gamut, the notification processing unit 28 notifies the user that the target color is able to be reproduced on the display D. For example, as illustrated in FIG. 11, the notification processing unit 28 causes a message such as “Reproduction will be successful without any problem.” to be displayed on the user interface.

The overview of the display diagnosis device 10 according to this exemplary embodiment is as described above. Prior to creation or adjustment of the color profile of the display D, the display diagnosis device 10 according to this exemplary embodiment is capable of carrying out a simulation regarding whether or not a target color desired by a user is present within a color gamut that varies according to a setting value of a white color specified by the user. Thus, the user is able to easily understand that the target color is able to be reproduced on the display D with the specified setting value of the white color, and this suppresses a situation in which the user repeatedly adjusts the color profile so that the target color is able to be reproduced on the display D.

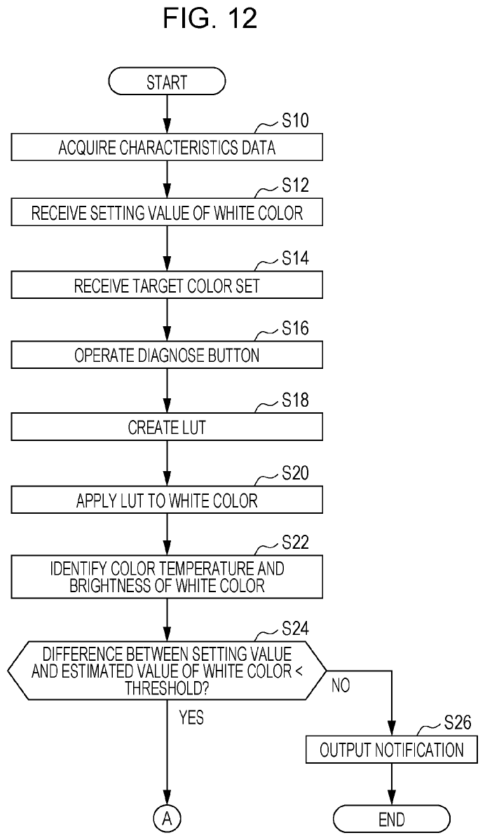

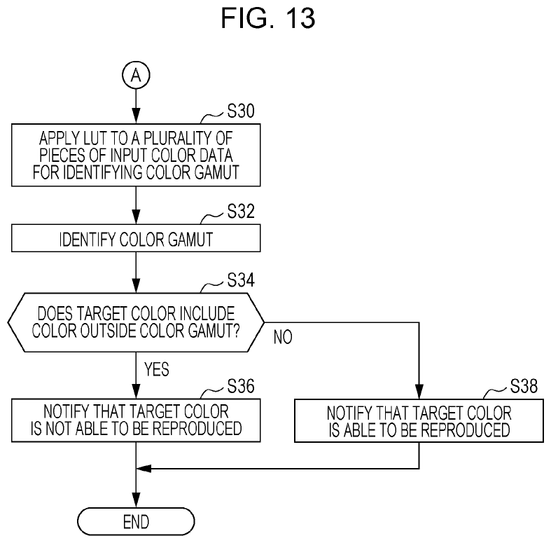

The flow of a process performed by the display diagnosis device 10 will be described below with reference to flowcharts illustrated in FIGS. 12 and 13.

In step S10, the processor 18 acquires the characteristics data 16 and causes the acquired characteristics data 16 to be stored into the memory 14.

In step S12, the processor 18 causes the user interface (see FIG. 2) to be displayed on the display D. The user inputs a setting value (brightness and color temperature) of a white color on the user interface. The white color setting unit 20 sets the setting value of the white color on the basis of the setting value input by the user.

In step S14, the user inputs a target color set on the user interface. The processor 18 determines the target color set on the basis of the target color set input by the user.

In step S16, when the user operates the diagnose button provided on the user interface, the processor 18 receives a diagnosis instruction.

In step S18, the white color accuracy determining unit 22 creates, based on the characteristics data 16 acquired in step S10, an LUT indicating the relationship between input color data (R,G,B) represented by the characteristics data 16 and input color data (R,G,B) representing the white color set in step S12.

In step S20, by applying the LUT created in step S18 to the input color data (R,G,B)=(255,255,255) representing the white color, the white color accuracy determining unit 22 converts the input color data (R,G,B)=(255,255,255) representing the white color into input color data (R,G,B) of the white color set in step S12 for the case where the white color represented by the characteristics data 16 is defined as a reference.

In step S22, the white color accuracy determining unit 22 identifies, based on the converted input color data (R,G,B) and the characteristics data 16, the brightness and color temperature of the white color set by the white color setting unit 20.

In step S24, the white color accuracy determining unit 22 compares the brightness identified in step S22 with the brightness set in step S12. Furthermore, the white color accuracy determining unit 22 compares the identified color temperature with the color temperature set by the white color setting unit 20. In the case where it is determined that at least one of the difference in brightness and the difference in color temperature is equal to or more than a predetermined threshold, the process proceeds to step S26.

In step S26, the notification processing unit 28 notifies the user that the white color set in step S12 is not able to be reproduced on the display D and ends the process.

In the case where it is determined in step S24 that each of the difference in brightness and the difference in color temperature is less than the predetermined threshold, the process proceeds to S30 (see FIG. 13).

In step S30, the color gamut identifying unit 24 applies the LUT created in step S18 to a plurality of pieces of input color data (R,G,B) that are prepared for identifying a color gamut.

In step S32, the color gamut identifying unit 24 identifies, based on the plurality of pieces of input color data (R,G,B) to which the LUT has been applied in step S30 and the characteristics data 16, the color gamut of the display D determined according to the setting value of the white color set in step S12.

In step S34, it is determined whether or not the target color set received in step S14 is present within the color gamut of the display D identified in step S32. In the case where at least one of target colors in the target color set is not present within the color gamut, the process proceeds to step S36.

In step S36, the notification processing unit 28 notifies the user that the target color is not able to be reproduced on the display D.

In step S34, in the case where all the target colors in the target color set are present within the color gamut, the process proceeds to step S38.

In step S38, the notification processing unit 28 notifies the user that the target color is able to be reproduced on the display D.

Although an exemplary embodiment according to the present disclosure has been described above, the present disclosure is not limited to the exemplary embodiment described above. Various changes may be made to the present disclosure without departing from the spirit of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A display diagnosis device comprising:
a processor configured to:
   receive a setting value of a white color on a display from a user;
   based on characteristics data and the setting value of the white color, the characteristics data being a combination of input color data representing a color and a color measurement value obtained by measuring a color displayed based on the input color data on the display, identify a color gamut that is a part of a color space that is able to be displayed on the display; and
in a case where a target color is not present within the identified color gamut, notify the user that the target color is not able to be reproduced on the display.
   (((2)))

The display diagnosis device according to (((1))), wherein the processor is configured to, in a case where the target color is not present within the identified color gamut, notify the user of a color difference between the target color and the color gamut.

(((3)))

The display diagnosis device according to (((1))) or (((2))), wherein the processor is configured to, in a case where the target color is not present within the identified color gamut, notify the user of a setting value of the white color that allows the target color to be included within the color gamut.

(((4)))

The display diagnosis device according to (((1))), wherein the processor is configured to determine the target color in accordance with an instruction from the user.

(((5)))

The display diagnosis device according to (((4))),
wherein one or a plurality of pieces of target color set data representing a plurality of target colors are prepared in advance, and
wherein the processor is configured to, based on target color set data selected by the user, determine the target color.
   (((6)))

The display diagnosis device according to (((1))), wherein the processor is configured to, in a case where the white color is not able to be reproduced based on the characteristics data and the setting value of the white color on the display, notify the user that the white color is not able to be reproduced on the display.

(((7)))

The display diagnosis device according to (((6))), wherein the processor is configured to, in a case where it is determined that the white color is able to be reproduced on the display, identify the color gamut.

(((8)))

A display diagnosis program for causing a computer to execute a process comprising:
receiving a setting value of a white color on a display from a user;
based on characteristics data and the setting value of the white color, the characteristics data being a combination of input color data representing a color and a color measurement value obtained by measuring a color displayed based on the input color data on the display, identifying a color gamut that is a part of a color space that is able to be displayed on the display; and
in a case where a target color is not present within the identified color gamut, notify the user that the target color is not able to be reproduced on the display.

What is claimed is:

1. A display diagnosis device comprising:
a processor configured to:
receive a setting value of a white color on a display from a user;
based on characteristics data and the setting value of the white color, the characteristics data being a combination of input color data representing a color and a color measurement value obtained by measuring a color displayed based on the input color data on the display, identify a color gamut that is a part of a color space that is able to be displayed on the display; and
in a case where a target color is not present within the identified color gamut, notify the user that the target color is not able to be reproduced on the display.

2. The display diagnosis device according to claim 1, wherein the processor is configured to, in a case where the target color is not present within the identified color gamut, notify the user of a color difference between the target color and the color gamut.

3. The display diagnosis device according to claim 1, wherein the processor is configured to, in a case where the target color is not present within the identified color gamut, notify the user of a setting value of the white color that allows the target color to be included within the color gamut.

4. The display diagnosis device according to claim 2, wherein the processor is configured to, in a case where the target color is not present within the identified color gamut, notify the user of a setting value of the white color that allows the target color to be included within the color gamut.

5. The display diagnosis device according to claim 1, wherein the processor is configured to determine the target color in accordance with an instruction from the user.

6. The display diagnosis device according to claim 5,
wherein one or a plurality of pieces of target color set data representing a plurality of target colors are prepared in advance, and
wherein the processor is configured to, based on target color set data selected by the user, determine the target color.

7. The display diagnosis device according to claim 1, wherein the processor is configured to, in a case where the white color is not able to be reproduced based on the characteristics data and the setting value of the white color on the display, notify the user that the white color is not able to be reproduced on the display.

8. The display diagnosis device according to claim 7, wherein the processor is configured to, in a case where it is determined that the white color is able to be reproduced on the display, identify the color gamut.

9. A display diagnosis method comprising:
receiving a setting value of a white color on a display from a user;
based on characteristics data and the setting value of the white color, the characteristics data being a combination of input color data representing a color and a color measurement value obtained by measuring a color displayed based on the input color data on the display, identifying a color gamut that is a part of a color space that is able to be displayed on the display; and
in a case where a target color is not present within the identified color gamut, notify the user that the target color is not able to be reproduced on the display.

10. A non-transitory computer readable medium storing a program causing a computer to execute a process for display diagnosis, the process comprising:
receiving a setting value of a white color on a display from a user;
based on characteristics data and the setting value of the white color, the characteristics data being a combination of input color data representing a color and a color measurement value obtained by measuring a color displayed based on the input color data on the display, identifying a color gamut that is a part of a color space that is able to be displayed on the display; and
in a case where a target color is not present within the identified color gamut, notify the user that the target color is not able to be reproduced on the display.
